(19) United States
(12) Patent Application Publication
(10) Pub. No.: US 2007/0237107 A1
(43) Pub. Date: Oct. 11, 2007

(54) Apparatus and method for transmitting packets in wireless access communication system using relay stations

(75) Inventors: Jae-Hyuk Jang, Suwon-si (KR); Dong-Seek Park, Yongin-si (KR); Young-Kwon Cho, Suwon-si (KR); Eun-Taek Lim, Suwon-si (KR); Young-Bin Chang, Anyang-si (KR); Kathiravetpillai Sivanesan, Suwon-si (KR); Cheng Shan, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/714,055

(22) Filed: Mar. 5, 2007

(30) Foreign Application Priority Data
Mar. 3, 2006 (KR) 2006-20243

(51) Int. Cl. H04B 7/14

(52) U.S. Cl. 370/315

(57) ABSTRACT

Provided is an apparatus and method for efficiently transmitting packets to MSs in a BWA system using RSs. A BS uses an ESH to combines packets, which are to be transmitted through RSs to MSs, into a larger packet prior to transmission. Alternatively, the BS transmits packets, which are to be transmitted to MSs, to an RS without discrimination therebetween, and the RS determines whether the packets are to be transmitted to the MSs, prior to transmission.

### PRIORITY

This application claims priority under 35 U.S.C. § 119 to a Korean application filed in the Korean Intellectual Property Office on Mar. 3, 2007 and allocated Serial No. 2006-20243, the contents of which are incorporated herein by reference.

### BACKGROUND OF THE INVENTION

1. Field of the Invention

The present invention relates generally to a broadband wireless access communication system, and more particularly, to an apparatus and method for efficiently transmitting packets to mobile stations (MSs) in a broadband wireless access communication system using relay stations (RSs).

2. Description of the Related Art

Recently, extensive research is being conducted to provide a variety of services with a data rate of about 100 Mbps or more in the advanced fourth-generation (4G) communication system. The 4G communication system is evolving to provide mobility, high data rate transmission, and high Quality of Service (QoS) in a broadband wireless access (BWA) system such as a Local Area Network (LAN) system and a Metropolitan Area Network (MAN) system. A typical example of the above system is identified in the Institute of Electrical and Electronics Engineers (IEEE) 802.16e system standard.

An IEEE 802.16e system uses an Orthogonal Frequency Division Multiplexing (OFDM) scheme or an Orthogonal Frequency Division Multiple Access (OFDMA) scheme for physical channels.

With the diversification of services provided using portable terminals, special attention is being drawn to a broadband system. An attempt is being made to install a new communication system independent of the conventional communication system. However, when additional base stations (BSs) are installed to construct an additional system, a high additional cost is required for installation of an additional wired network. Accordingly, attention is being drawn to a scheme for adding an RS between a BS and an MS for communication. For example, an RS is used to expand a service area (coverage) or to increase a data transmission rate through a diversity effect. In this case, a received signal is transmitted using an Amplify & Forward (AF) scheme or a Decode & Forward (DF) scheme. The AF scheme simply amplifies a received signal prior to transmission, while the DF scheme decodes a received signal prior to transmission.

FIG. 1 is a block diagram of a general BWA system using RSs. The RSs are used to expand the service coverage.

Referring to FIG. 1, MSs (hereinafter referred to as “near MSs”) in the coverage area of a BS communicate directly with the BS, while MSs (hereinafter referred to as “far MSs”) outside the coverage area of the BS communicate with the BS via the RSs.

FIG. 2 is a diagram illustrating a general frame format for a Time Division Duplexing (TDD) system using RSs. In particular, FIG. 2 illustrates a frame format for an OFDMA TDD system using RSs.

Referring to FIG. 2, in terms of a time axis, the frame format includes a downlink (DL) frame and an uplink (UL) frame. The DL frame includes a subframe 201 for transmission from a BS to near MSs and RSs and a subframe 203 for retransmission from RSs to far MSs. The UL frame includes a subframe 205 for transmission from far MSs to RSs and a subframe 207 for transmission from near MSs and RSs to a BS.

For example, a plurality of RSs belong to a BS and each RS transmits a received signal using an AF scheme or a DF scheme. For transmission from a BS to a far MS, information about a target RS is needed to determine which RS is to be used for retransmission. In the DF scheme, resources may be reallocated for the subframe 203 for retransmission from the target RS to the far MS, which may require Modulation and Coding Scheme (MCS) information and resource allocation information. In this case, information about the target RS, resource allocation information and MCS information of the target RS may be managed by a BS or by an RS, so there is information to be transmitted from the BS to the target RS and information not to be transmitted from the BS to the target RS.

### SUMMARY OF THE INVENTION

Therefore, the format of a packet transmitted by the BS must be defined for the AF scheme and for the DF scheme. Also required is a BS device for generating the defined frame format and a method for transmitting the same.

An aspect of the present invention is to substantially solve at least the above problems and/or disadvantages and to provide at least the advantages below. Accordingly, an object of the present invention is to provide a transmitter for efficiently transmitting packets to MSs in a BWA system using RSs.

Another aspect of the present invention is to provide a method for efficiently transmitting packets from a transmitter to MSs in a BWA system using RSs.

Still another aspect of the present invention is to provide an RS for efficiently transmitting packets to MSs in a BWA system using RSs.

Even another aspect of the present invention is to provide a method for efficiently transmitting packets from an RS to MSs in a BWA system using RSs.

According to an aspect of the present invention, a transmitter, for transmitting packets to receivers in a BWA system, includes a receiver-relay station information storage for storing channel information of a first receiver for receiving a packet directly from the transmitter, channel information of a second receiver for receiving a packet from the transmitter through a relay station, and channel information of the relay station; and a packet generator for generating the packets in such a way that a first frame format of a packet containing the channel information of the first receiver and the relay station, which is stored by the first receiver/the relay station for transmission of the packet through the relay station, is different from a second frame format of a packet containing the channel information of the second receiver, which is stored by the second receiver/the relay station for transmission of the packet directly to the second receiver.

According to another aspect of the present invention, a relay station, for transmitting packets to a receiver in a BWA system, includes an RF receiver for receiving packets from a transmitter; a packet analyzer for analyzing the received packets to classify the received packets into a packet whose final destination is the relay station and a retransmission packet whose final destination is the receiver; a packet generator for generating the retransmission packet into a new packet with a format suitable for transmission to the receiver; a MAP generator for generating a MAP channel that is resource allocation control information of the retransmission packet; and an RF transmitter for transmitting the new packet and the MAP channel to the receiver.

According to a further aspect of the present invention, a transmitter, for transmitting packets to receivers in a BWA system, includes a receiver-relay station information storage for storing channel information of a first receiver for receiving a packet directly from the transmitter, channel information of a second receiver for receiving a packet from the transmitter through a relay station, and channel information of the relay station; and a packet generator for generating the packets sharing a frame format of a packet containing the channel information of the first receiver and the relay station, which is stored by the first receiver/the relay station for transmission of the packet through the relay station.

According to a still further aspect of the present invention, a relay station, for transmitting packets to a receiver in a BWA system, includes an RF receiver for receiving packets from a transmitter; a packet analyzer for analyzing the received packets; a receiver information storage for storing channel information of receives covered by the relay station; a packet generator for comparing the packet information analyzed by the packet analyzer with the information stored in the receiver information storage to generate a retransmission packet, whose final destination is the receiver, into a new packet with a format suitable for transmission to the receiver; a MAP generator for generating a MAP channel that is resource allocation control information of the retransmission packet; and an RF transmitter for transmitting the new packet and the MAP channel to the receiver.

According to a still further aspect of the present invention, a method for transmitting packets to receivers in a BWA system, that includes determining if a packet is to be transmitted to the receiver directly or through a relay station; generating a first packet with a first frame format for transmission through the relay station to the receiver and a second packet with a second frame format for transmission directly to the receiver; and transmitting the first packet to the receiver.

According to a still further aspect of the present invention, a method, for relaying packets to a receiver in a BWA system, that includes receiving packets from a transmitter; analyzing the received packets to classify the received packets into a packet whose final destination is a relation station and a retransmission packet whose final destination is the receiver; generating the retransmission packet into a new packet with a format suitable for transmission to the receiver; generating a MAP channel that is resource allocation control information of the retransmission packet; and transmitting the new packet and the MAP channel to the receiver.

According to a still further aspect of the present invention, a method, for transmitting packets to receivers in a BWA system, that includes determining if a packet is to be transmitted to the receiver directly or through a relay station; generating a packet with a frame format that is commonly used both for transmission through the relay station to the receiver and for transmission directly to the receiver; and transmitting the generated packet to the receiver.

According to a still further aspect of the present invention, a method, for relaying packets to a receiver in a BWA system, that includes storing channel information of receives covered by a relay station; receiving packets from a transmitter, analyzing the received packets and comparing the analyzed packet information analyzed with the stored channel information to generate a retransmission packet, whose final destination is the receiver, into a new packet with a format suitable for transmission to the receiver; generating a MAP channel that is resource allocation control information of the retransmission packet; and transmitting the new packet and the MAP channel to the receiver.

### BRIEF DESCRIPTION OF THE DRAWINGS

The above and other aspects, features and advantages of the present invention will become more apparent from the following detailed description when taken in conjunction with the accompanying drawings in which:

FIG. 1 is a block diagram of a general BWA system using RSs;

FIG. 2 is a diagram illustrating a general frame format for a TDD system using RSs;

FIGS. 3A and 3B are block diagrams of a BS and an RS for a BWA system using RSs according to the present invention;

FIG. 4 is a diagram illustrating a frame format for the BWA system using the BS and the RS illustrated in FIG. 3;

FIGS. 5A and 5B are block diagrams of a BS and an RS for a BWA system using RSs according to the present invention;

FIGS. 6A and 6B are flowcharts illustrating frame-processing operations of the BS and the RS illustrated in FIG. 3; and

FIGS. 7A and 7B are flowcharts illustrating frame-processing operations of the BS and the RS illustrated in FIG. 5.

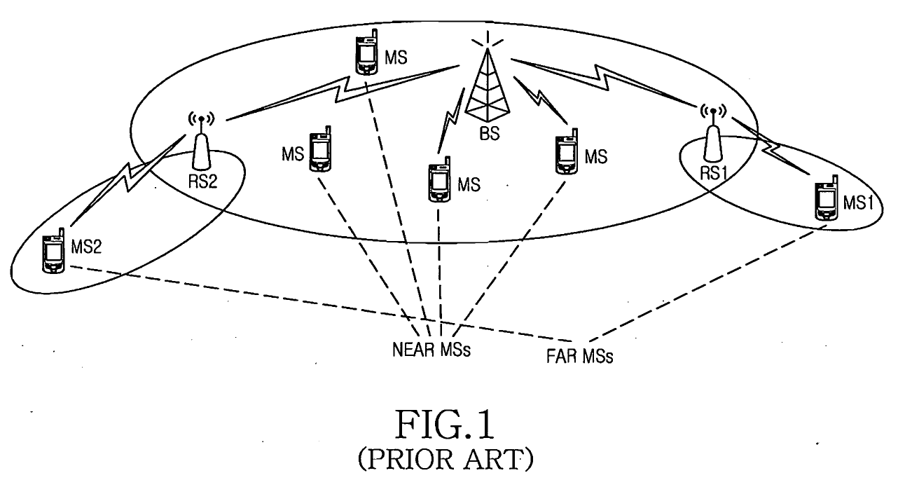

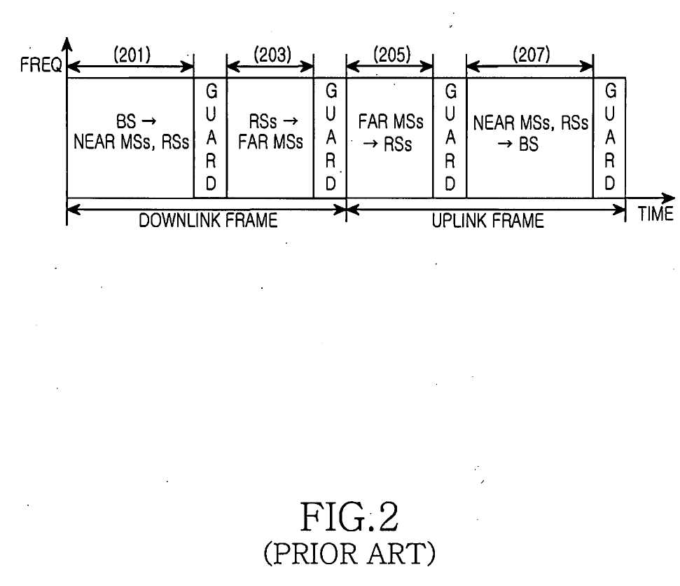

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides an apparatus and method for efficiently transmitting packets to MSs in a BWA system using RSs. In an embodiment of the present invention, a BS uses an extended subheader (ESH) to combines packets, which are to be transmitted through RSs to MSs, into a larger packet prior to transmission. In another embodiment of the present invention, a BS transmits packets, which are to be transmitted to MSs, to an RS without discrimination therebetween, and the RS determines whether the packets are to be transmitted to the MSs, prior to transmission.

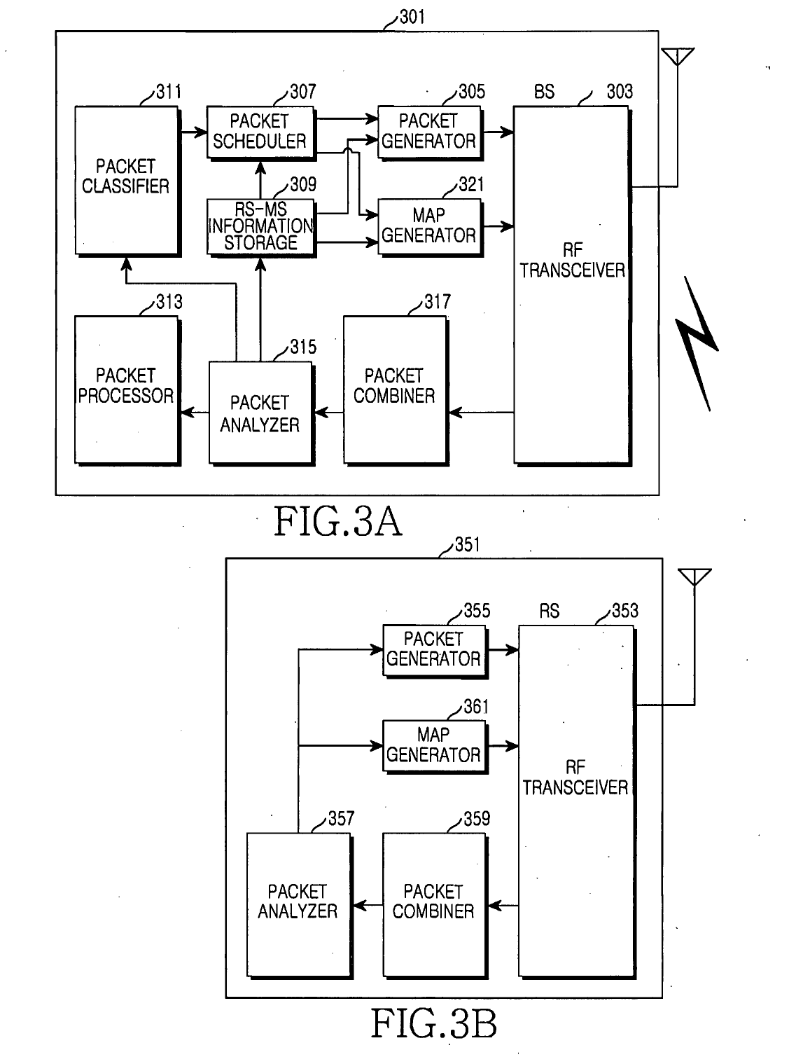

FIGS. 3A and 3B are block diagrams of a BS and an RS for a BWA system using RSs according to the present invention. In this embodiment, the BS determines which RS will relay a packet destined for an MS. The BS allocates a resource allocation interval and MCS information of an RS in a subframe for transmission of a packet from an RS to a far MS. In this case, the RS is simple in structure and there is no structural change in the MS.

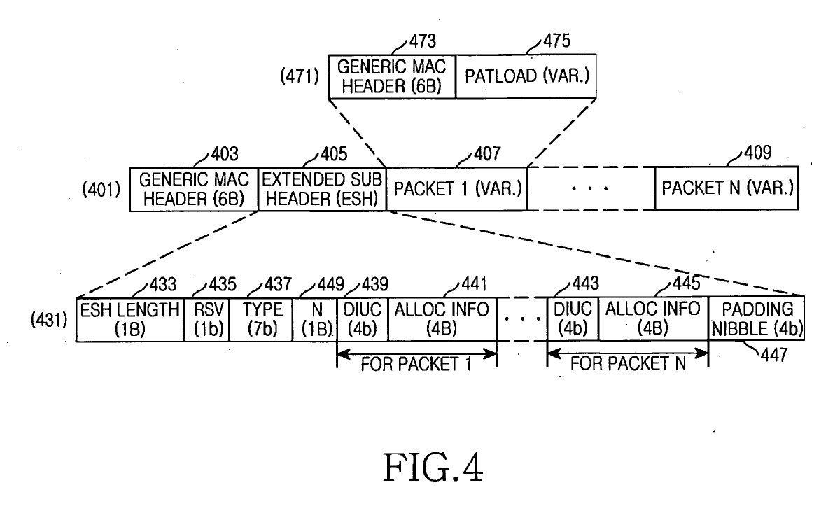

Referring to FIG. 3A, a BS 301 includes an antenna, an RF transceiver 303, a packet generator 305, a packet scheduler 307, an RS-MS information storage 309, a packet classifier 311, a packet processor 313, a packet analyzer 315, a packet combiner 317, and a MAP generator 321. The packet classifier 311 classifies received packets according to information about a target MS and a QoS feature. The packet scheduler 307 receives the classified packets and schedules TX packets according to RS channel state information and MS channel state information that are stored in the RS-MS information storage 309. The RS-MS information storage 309 stores not only channel information of near MSs but also channel information of far MSs. After the TX schedule is determined by the packet scheduler 307, the packet generator 305 generates packets in different formats according to whether the packets will be directly transmitted to MSs or transmitted through RSs. Packets, which will be transmitted through RSs to MSs, are combined into a larger packet prior to transmission. A packet format for this will be described later with reference to FIG. 4. The MAP generator 321 generates resource allocation information. The RF transceiver 303 transmits a MAP channel containing the generated resource allocation information and the packet generated by the packet generator 305. The packet combiner 317, the packet analyzer 315, and the packet processor 313 function for reception of packets from MSs or RSs via UL channels.

Referring to FIG. 3B, an RS 351 includes an antenna, an RF transceiver 353, a packet generator 355, a packet analyzer 357, a packet combiner 359, and a MAP generator 361. The RS 351 receives packets from the BS 301. When the RF transceiver 353 receives packets from the BS 301, the packet combiner 359 combines the received packets. The packet analyzer 357 analyzes the received packets to classify the received packets according to whether the final destinations of the received packets are RSs or MSs. Those packets whose final destinations are MSs will be retransmitted to the MSs. The packet generator 355 re-analyzes the contents of such retransmission packets and re-generates the retransmission packets in formats suitable for transmission to the MSs. The MAP generator 361 generates a MAP channel that corresponds to resource allocation control information of the packets analyzed by the packet analyzer 357. The RF transceiver 353 transmits the packets generated by the packet generator 355 and the MAP channel generated by the MAP generator 361 to the corresponding MSs.

FIG. 4 is a diagram illustrating a frame format for the BWA system using the BS and the RS illustrated in FIG. 3. The frame format is used for transmission of a packet from the BS to the RS. The frame format is newly proposed for the BS to inform which RS must retransmit a packet to an RS, and is also compatible with the IEEE 802.16e standard.

Referring to FIG. 4, a packet 401 corresponds to a frame format of the entire packet that is transmitted from the BS to the RS. The packet 401 includes a 6-byte Generic MAC Header 403, an Extended Subheader (ESH) 405 whose size is determined depending on the number of accompanying packets, and N number of the accompanying packets 407, . . . , 409 (N is the variable number of packets transmitted via the RS). Each of the packets has a format denoted by a reference numeral 471. Each packet includes a 6-byte generic MAC header 473 and a variable-sized payload 475 and follows a packet format specified in the IEEE 802.16e standard.

The ESH 405 is used to transmit MCS level information and resource allocation information that are used for transmission of packets from RSs to MSs. As described above, the size of the ESH 405 is variable depending on the number N of the accompanying packets. The ESH 405 has a format denoted by a reference numeral 431. The ESH 431 uses a header format specified in the IEEE 802.16e standard. However, since 122 reserved types remain undefined in the IEEE 802.16e, one of the 122 reserved types are used. The ESH 431 includes a 1-byte ESH Length field 433, a 1-bit Reserved field 435, a Type field 437 (7 bits), a Packet Number (N) field 449 (1 Byte), Downlink Interval Usage Code (DIUC) fields/Allocation Information fields 439/441, . . . , 443/445, and a Padding Nibble field 447 (4 bits). The Type field 437 is used to indicate that a packet format is intended to be a format for an RS. The DIUC field and the Allocation Information field are repeated N times, and the DIUC field corresponds MCS Set. The DIUC fields and the Allocation Information fields contain the MCS information and resource allocation information of the accompanying packets. The padding nibble is used for byte alignment. If the number N of packets are odd, the padding nibble is padded to reach a byte boundary. Therefore, if there is no other ESH, the total length of the ESH is (3+4.5×N) bytes (N: even numbers) or (3+4.5×N+0.5) bytes (N: odd numbers).

The Generic MAC Header 403 includes a Destination Address field and a Total Packet Length field. The Destination Address field contains an RS address. The Total Packet Length field contains the sum of the ESH length and the N packet lengths.

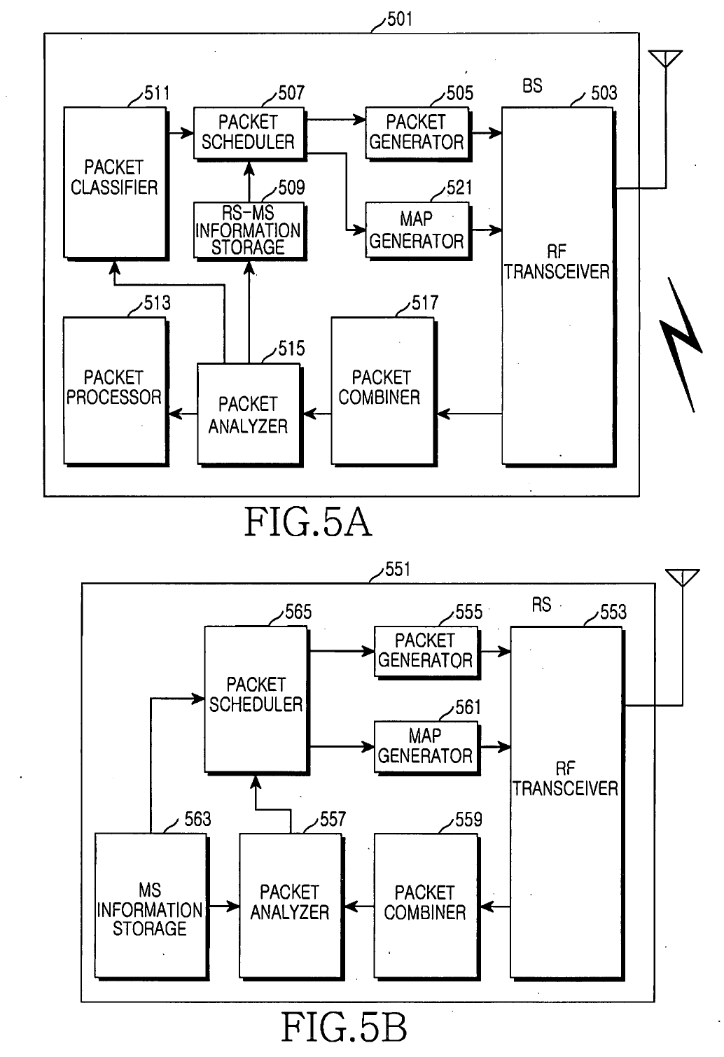

FIGS. 5A and 5B are block diagrams of a BS and an RS for a BWA system using RSs according to the present invention. In this embodiment, the RS itself allocates MCS information and resources in a subframe for transmission of a packet from an RS to a far MS. In this case, the RS already has information about MSs within its coverage. Therefore, the BS need not use the Generic MAC Header and the ESH.

Referring to FIG. 5A, a BS 501 includes an antenna, an RF transceiver 503, a packet generator 505, a packet scheduler 507, an RS-MS information storage 509, a packet classifier 511, a packet processor 513, a packet analyzer 515, a packet combiner 517, and a MAP generator 521. The BS 501 is very similar in structure to the BS 301 illustrated in FIG. 3A. The packet classifier 511 classifies received packets according to information about a target MS and a QoS feature. The packet scheduler 507 receives the classified packets and schedules TX packets. The RS-MS information storage 509 is different in function from the RS-MS information storage 309 illustrated in FIG. 3A. That is, the RS-MS information storage 309 stores the channel state of the RS, the channel information of near MSs, and the channel information of far MSs, whereas the RS-MS information storage 509 does not store the channel information of near MSs. Accordingly, the RS-MS information storage 509 does not provide the packet generator 505 with information about whether the corresponding packet is to be transmitted through the RS. All packets have a MAC packet format denoted by the reference numeral 471 in FIG. 4. Packets transmitted through an RS to an MS also contains only an MS destination address in the Generic MAC Header 473. After the TX schedule is determined by the packet scheduler 507, the packet generator 505 generates TX packets. The MAP generator 521 generates resource allocation information. The RF transceiver 503 transmits a MAP channel containing the generated resource allocation information and the packet generated by the packet generator 505. The packet combiner 517, the packet analyzer 515, and the packet processor 513 function for reception of packets from MSs or RSs via UL channels.

Referring to FIG. 5B, an RS 551 includes an antenna, an RF transceiver 553, a packet generator 555, a packet analyzer 557, a packet combiner 559, a MAP generator 561, an MS information storage 563, and a packet scheduler 565. The RF transceiver 553 receives TX packets from the BS 501. The packet combiner 559 combines the received packets into an original format. The packet analyzer 557 analyzes the Generic MAC Header of the combined packets. Referring to the MS information storage 563 storing information of MSs covered by the RS, it is determined whether the corresponding packet must be retransmitted to an MS. The MS information storage 563 stores MCS levels of MSs and QoS features of MS traffics. Based on MCS information, the packet scheduler 565 schedules packets that are to be retransmitted to MSs. According to the schedule, the packet generated by the packet generator 555 and the MAP information generated by the MAP generator 561 are transmitted through the RF transceiver 553 to a target MS. A separate header format is unnecessary because the necessity of the retransmission is determined according to only the target MS address contained in the Generic MAC Header of the corresponding packet by using the MS information stored in the MS information storage 563. Accordingly, the retransmission to an MS can be performed also by the conventional format specified in the IEEE 802.16e.

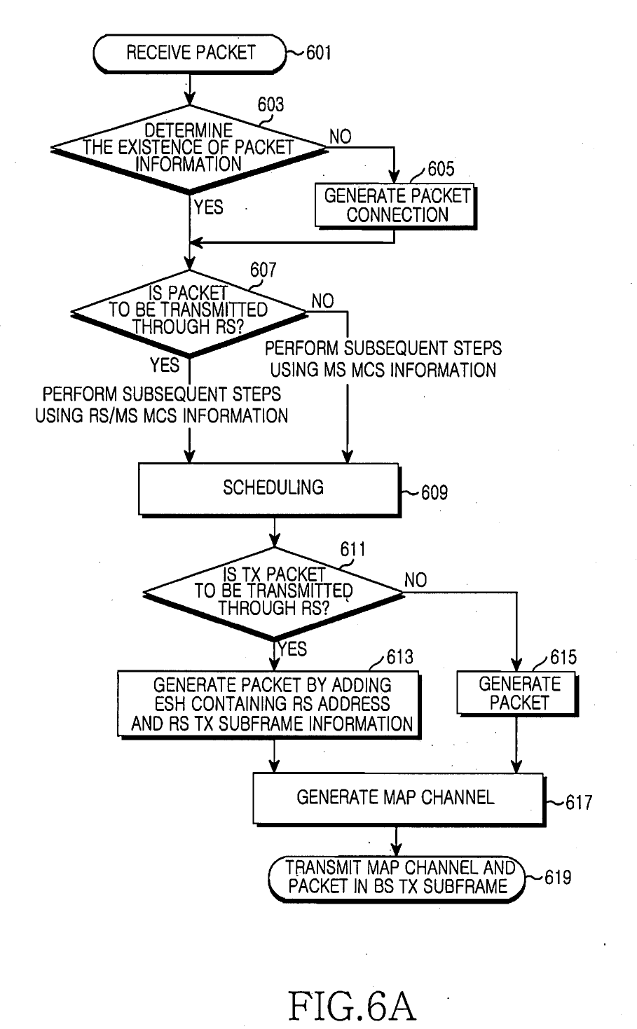

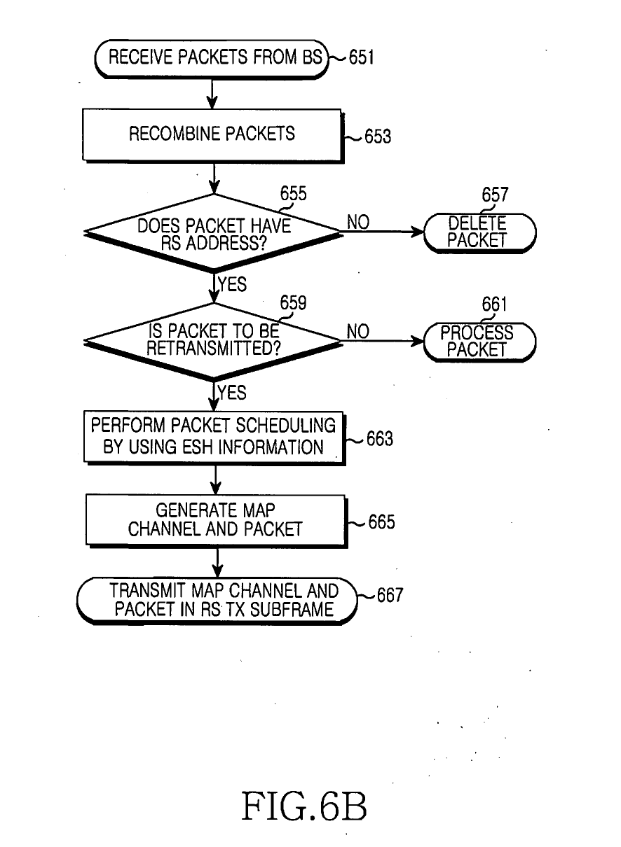

FIGS. 6A and 6B are flowcharts illustrating frame-processing operations of the BS and the RS illustrated in FIG. 3. That is, FIGS. 6A and 6B illustrate how a frame format and a packet transmission are performed using the devices of FIG. 3.

Referring to FIG. 6A, the BS receives a packet from a core network in step 601. In step 603, the BS determines if information of the received packet exists therein. If so, the operation proceeds to step 607; and if not, the operation proceeds to step 605. In step 605, the BS generates a packet connection and stores a QoS profile of the packet. During the generation of the packet connection, the BS transmits a Dynamic Service Addition Request (DSA-REQ) message directly to a corresponding MS or through a corresponding RS, and receives a corresponding DSA-Response (DSA-RSP) message from the corresponding MS. In step 607, based on the destination address information, the BS determines if the packet is to be transmitted through an RS to an MS. If so, the BS considers BS-RS MCS information and RS-MS MCS information; and if not (i.e., if the packet is to be transmitted directly to an MS), the BS considers BS-MS MCS information. In step 609, in consideration of QoS features, a packet scheduler of the BS performs a packet scheduling to determine a packet to be transmitted. In step 611, the BS determines if the determined packet is to be transmitted to an RS. If so, the operation proceeds to step 613; and if not, the operation proceeds to step 615. In step 613, a packet to be transmitted to an RS is generated by adding the Generic MAC Header containing RS information and the ESH containing transmission information of an RS-MS DL subframe. In step 615, a packet to be transmitted directly to an MS is generated using the Generic MAC Header specified in the IEEE 802.16e standard. In step 617, a MAP channel is generated according to the generated packets. In step 619, a transmitter of the BS transmits the generated MAP channel and the generated packets in a BS TX subframe.

Referring to FIG. 6B, the RS receives packets from a BS in step 651. In step 653, the RS recombines the received packets for analysis. In step 655, the RS checks a destination address contained in the Generic MAC Header of the packet, to determine if the packet has an RS address. If so, the operation proceeds to step 659; and if not, the RS deletes the packet in step 657. In step 659, the RS checks ESH information to determine if the packet is to be retransmitted. If so, the operation proceeds to step 663; and if not, the RS processes the packet according to packet types in step 661. In step 663, the RS performs a packet scheduling by using ESH information. In step 665, the RS generates a MAP channel and a packet according to the packet scheduling. In step 667, the RS transmits the generated MAP channel and the generated packet to a corresponding MS in an RS TX subframe.

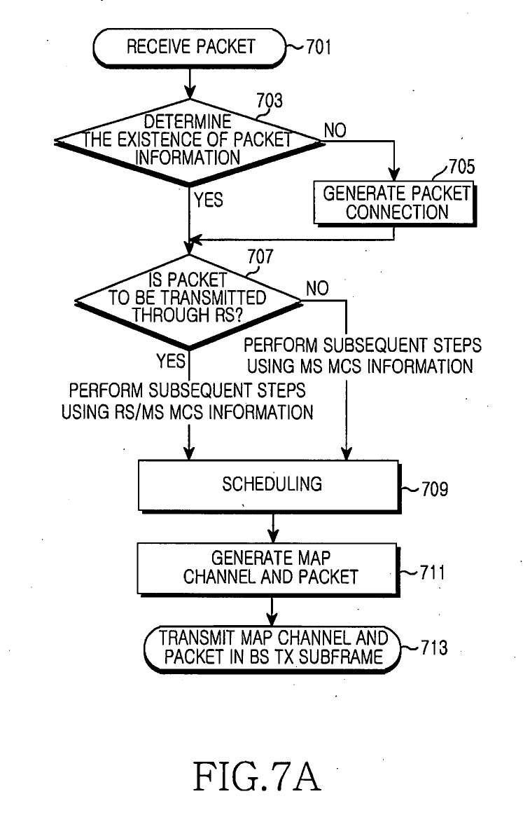

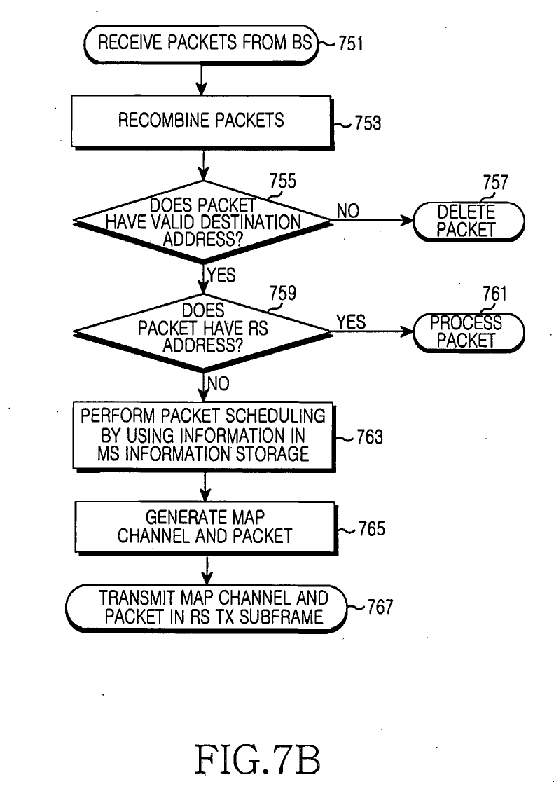

FIGS. 7A and 7B are flowcharts illustrating frame-processing operations of the BS and the RS illustrated in FIG. 5. A FIG. 7A BS operation is similar to a FIG. 6A BS operation. The main difference of the FIG. 7A BS operation from the FIG. 6A BS operation is that all packets are generated according to the packet format specified in the IEEE 802.16e standard in step 711.

Referring to FIG. 7A, the BS receives a packet from a core network in step 701. In step 703, the BS determines if information of the received packet exists therein. If so, the operation proceeds to step 707; and if not, the operation proceeds to step 705. In step 705, the BS generates a packet connection and stores a QoS profile of the packet. During the generation of the packet connection, the BS transmits a DSA-REQ message to a corresponding MS directly or through a corresponding RS and receives a corresponding DSA-RSP message from the corresponding MS. In step 707, based on the destination address information, the BS determines if the packet is to be transmitted through an RS to an MS. If so, the BS considers BS-RS MCS information and RS-MS MCS information; and if not (i.e., if the packet is to be transmitted directly to an MS), the BS considers BS-MS MCS information. In step 709, in consideration of QoS features, a packet scheduler of the BS performs a packet scheduling to determine a packet to be transmitted. In step 711, all packets are generated using the Generic MAC Header specified in the IEEE 802.16e standard and then a MAP channel is generated according to the generated packets. In step 713, a transmitter of the BS transmits the generated MAP channel and the generated packets in a BS TX subframe.

Referring to FIG. 7B, the RS receives packets from a BS in step 751. In step 753, the RS recombines the received packets for analysis. In step 755, the RS checks a destination address contained in the Generic MAC Header of the packet, to determine if the packet has a valid destination address. If so, the operation proceeds to step 759; and if not, the RS deletes the packet in step 757. The valid destination address refers to an address of the RS and an address stored in the MS information storage 563 (see FIG. 5B). In step 759, the RS determines if the packet has the RS address. If so, the RS processes the packet according to a packet type in step 761; and if not, the operation proceeds to step 763. In step 763, the RS performs a packet scheduling by using information stored in the MS information storage 563. In step 765, the RS generates a MAP channel and a packet according to the packet scheduling. In step 767, the RS transmits the generated MAP channel and the generated packet to a corresponding MS in an RS TX subframe.

Transmission of packets from the MS through the RS to the BS can be performed in the same way as the transmission of packets from the BS through the RS to the MS, which has been described above.

As described above, in the BWA system using RSs, the BS uses an ESH to combines packets, which are to be transmitted through RSs to MSs, into a larger packet prior to transmission. Alternatively, the BS transmits packets, which are to be transmitted to MSs, to an RS without discrimination therebetween, and the RS determines whether the packets are to be transmitted to the MSs, prior to transmission. Accordingly, it is possible to provide an efficient packet transmission using the minimum overhead.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A transmitter for transmitting packets to receivers in a wireless access system, the transmitter comprising:
a receiver-relay station information storage for storing channel information of a first receiver for receiving a packet directly from the transmitter, channel information of a second receiver for receiving a packet from the transmitter through a relay station, and channel information of the relay station; and
a packet generator for generating the packets such that a first frame format of a packet containing the channel information of the first receiver and the relay station, which is stored by the first receiver or the relay station for transmission of the packet through the relay station, is different from a second frame format of a packet containing the channel information of the second receiver, which is stored by the second receiver or the relay station for transmission of the packet directly to the second receiver.

2. The transmitter of claim 1, wherein the first frame format includes a Generic MAC Header, N number of packets, and an Extended Subheader whose size is determined according to the number of packets accompanying the Generic MAC Header.

3. The transmitter of claim 2, wherein each of the N packets includes a Generic MAC Header and a variable-sized payload.

4. The transmitter of claim 2, wherein the Extended Subheader serves to transmit MCS level information and resource allocation information that are used for transmission of the packet from the relay station to the receiver.

5. The transmitter of claim 4, wherein the Extended Subheader uses one of a plurality of reserved types.

6. The transmitter of claim 1, further comprising a packet scheduler for determining a packet schedule when the packet generator generates the packet to be transmitted to the receiver.

7. The transmitter of claim 6, wherein if the transmitter is a base station, the transmitter further comprises a packet classifier for classifying packets received from a core network, prior to transmission to the packet scheduler.

8. The transmitter of claim 6, wherein the packet scheduler schedules packets to be transmitted, according to the channel information of the relay station and the channel information of the receiver that are stored in the receiver-relay station information storage.

9. A relay station for transmitting packets to a receiver in a wireless access system, the relay station comprising:
an RF receiver for receiving packets from a transmitter;
a packet analyzer for analyzing the received packets to classify the received packets into a packet whose final destination is the relay station and a retransmission packet whose final destination is the receiver;
a packet generator for generating the retransmission packet into a new packet with a format suitable for transmission to the receiver;
a MAP generator for generating a MAP channel that is resource allocation control information of the retransmission packet; and
an RF transmitter for transmitting the new packet and the MAP channel to the receiver.

10. A transmitter for transmitting packets to receivers in a wireless access system, the transmitter comprising:
a receiver-relay station information storage for storing channel information of a first receiver for receiving a packet directly from the transmitter, channel information of a second receiver for receiving a packet from the transmitter through a relay station, and channel information of the relay station; and
a packet generator for generating the packets sharing a frame format of a packet containing the channel information of the first receiver and the relay station, which is stored by the first receiver or the relay station for transmission of the packet through the relay station.

11. The transmitter of claim 10, wherein the frame format includes a Generic MAC Header and a variable-sized payload.

12. The transmitter of claim 10, further comprising a packet scheduler for determining a packet schedule when the packet generator generates the packet to be transmitted to the receiver.

13. The transmitter of claim 12, wherein if the transmitter is a base station, the transmitter further comprises a packet classifier for classifying packets received from a core network, prior to transmission to the packet scheduler.

14. The transmitter of claim 12, wherein the packet scheduler schedules packets to be transmitted, according to the channel information of the relay station and the channel information of the receiver that are stored in the receiver-relay station information storage.

15. A relay station for transmitting packets to a receiver in a wireless access system, the relay station comprising:
an RF receiver for receiving packets from a transmitter;
a packet analyzer for analyzing the received packets;
a receiver information storage for storing channel information of receives covered by the relay station;
a packet generator for comparing the packet information analyzed by the packet analyzer with the information stored in the receiver information storage to generate a retransmission packet, whose final destination is the receiver, into a new packet with a format suitable for transmission to the receiver;
a MAP generator for generating a MAP channel that is resource allocation control information of the retransmission packet; and
an RF transmitter for transmitting the new packet and the MAP channel to the receiver.

16. A method for transmitting packets to receivers in a wireless access system, the method comprising the step of:
determining if a packet is to be transmitted directly to the receiver or transmitted through a relay station;
generating a first packet with a first frame format for transmission through the relay station to the receiver and a second packet with a second frame format for transmission directly to the receiver; and
transmitting the first packet to the receiver.

17. The method of claim 16, wherein the first frame format includes a Generic MAC Header, N number of packets, and an Extended Subheader whose size is determined according to the number of packets accompanying the Generic MAC Header.

18. The method of claim 17, wherein each of the N packets includes a Generic MAC Header and a variable-sized payload.

19. The method of claim 17, wherein the Extended Subheader serves to transmit MCS level information and resource allocation information that are used for transmission of the packet from the relay station to the receiver.

20. The method of claim 19, wherein the Extended Subheader uses one of a plurality of reserved types.

21. A method for relaying packets to a receiver in a wireless access system, the method comprising the steps of:
receiving packets from a transmitter;
analyzing the received packets to classify the received packets into a packet whose final destination is a relation station and a retransmission packet whose final destination is the receiver;
generating the retransmission packet into a new packet with a format suitable for transmission to the receiver;
generating a MAP channel that is resource allocation control information of the retransmission packet; and
transmitting the new packet and the MAP channel to the receiver.

22. A method for transmitting packets to receivers in a wireless access system, the method comprising the step of:
determining if a packet is to be transmitted directly to the receiver or transmitted through a relay station;
generating a packet with a frame format that is commonly used both for transmission through the relay station to the receiver and for transmission directly to the receiver; and
transmitting the generated packet to the receiver.

23. The method of claim 22, wherein the frame format includes a Generic MAC Header and a variable-sized payload.

24. A method for relaying packets to a receiver in a BWA system, the method comprising the steps of:
storing channel information of receives covered by a relay station;
receiving packets from a transmitter, analyzing the received packets and comparing the analyzed packet information analyzed with the stored channel information to generate a retransmission packet, whose final destination is the receiver, into a new packet with a format suitable for transmission to the receiver;
generating a MAP channel that is resource allocation control information of the retransmission packet; and
transmitting the new packet and the MAP channel to the receiver.
